(19) United States
(12) Patent Application Publication
(10) Pub. No.: US 2012/0182642 A1
(43) Pub. Date: Jul. 19, 2012

(54) HARD DISK DEVICE, DISK, AND METHOD FOR CALCULATING DISPLACEMENT AMOUNT OR POSITION CORRECTION AMOUNT OF HEAD

(75) Inventors: Naoki KIMURA, Kanagawa (JP); Tatsurou Sasamoto, Tokyo (JP)

(73) Assignee: Kabushiki Kaisha Toshiba, Tokyo (JP)

(21) Appl. No.: 13/274,154

(22) Filed: Oct. 14, 2011

(30) Foreign Application Priority Data
Jan. 14, 2011 (JP) 2011-006267

(51) Int. Cl. G11B 21/02; G11B 5/82

(52) U.S. Cl. 360/75; 360/135; G9B/5.293; G9B/21.003

(57) ABSTRACT

A hard disk device includes a disk, a head, and a calculator. The disk includes a plurality of first areas arranged spaced apart in the circumferential direction on a surface of the disk and data-rewritable second areas each located between an adjacent pair of the first areas in the circumferential direction. First servo data is written in the first areas, while second servo data is written in the second areas. The head reads the first servo data and the second servo data written to the surface of the disk. The calculator calculates a displacement amount or a position correction amount of the head based on a result of reading the first servo data and the second servo data by the head.

### CROSS-REFERENCE TO RELATED APPLICATIONS

This application is based upon and claims the benefit of priority from Japanese Patent Application No. 2011-006267, filed Jan. 14, 2011, the entire contents of which are incorporated herein by reference.

### FIELD

Embodiments described herein relate generally to a hard disk device, a disk, and a method for calculating a displacement amount or a position correction amount of a head.

### BACKGROUND

There has been known a hard disk device that performs head positioning control using data on a displacement amount or a position correction amount of the head. In this type of hard disk device, at the manufacturing stage, servo data is written in servo data areas arranged spaced apart in the circumferential direction on a surface of a disk. A displacement amount is calculated based on a result of reading the servo data by the head. At this time, to increase the accuracy of positioning control, the disk is rotated several revolutions, and servo data is measured several times with respect to each servo data area. Then, the average of displacement amounts or correction amounts based on a result of the several measurements or the like is calculated as a displacement amount or a correction amount corresponding to the servo data area. The calculated displacement amount or correction amount is stored in a hard disk. In positioning control of the head at the time of using the hard disk device, the stored displacement amount or correction amount is used.

In the conventional hard disk device, it takes time to calculate a displacement amount or a correction amount because the disk is rotated several revolutions as described above.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic block diagram of a hard disk device according to a first embodiment;

FIG. 2 is an exemplary schematic block diagram of a microprocessing unit (MPU) of the hard disk device in the first embodiment;

FIG. 3 is an exemplary diagram for explaining a configuration of a data area of a disk in the hard disk device in the first embodiment;

FIG. 4 is an exemplary flowchart of how to calculate a displacement amount in the first embodiment;

FIG. 5 is an exemplary schematic diagram of servo data and tracks of the disk in the hard disk device in the first embodiment;

FIG. 6 is an exemplary schematic block diagram of an MPU of a hard disk device according to a second embodiment;

FIG. 7 is an exemplary flowchart of how to calculate a displacement amount in the second embodiment; and

FIG. 8 is an exemplary detailed flowchart of the process at S23 of FIG. 7 in the second embodiment.

### DETAILED DESCRIPTION

In general, according to one embodiment, a hard disk device comprises includes a disk, a head, and a calculator. The disk comprises a plurality of first areas arranged spaced apart in the circumferential direction on a surface of the disk and data-rewritable second areas each located between an adjacent pair of the first areas in the circumferential direction. First servo data is written in the first areas, while second servo data is written in the second areas. The head is configured to read the first servo data and the second servo data written to the surface of the disk. The calculator is configured to calculate a displacement amount or a position correction amount of the head based on a result of reading the first servo data and the second servo data by the head.

In exemplary embodiments described below, like elements are designated by like reference numerals, and their description is not repeated.

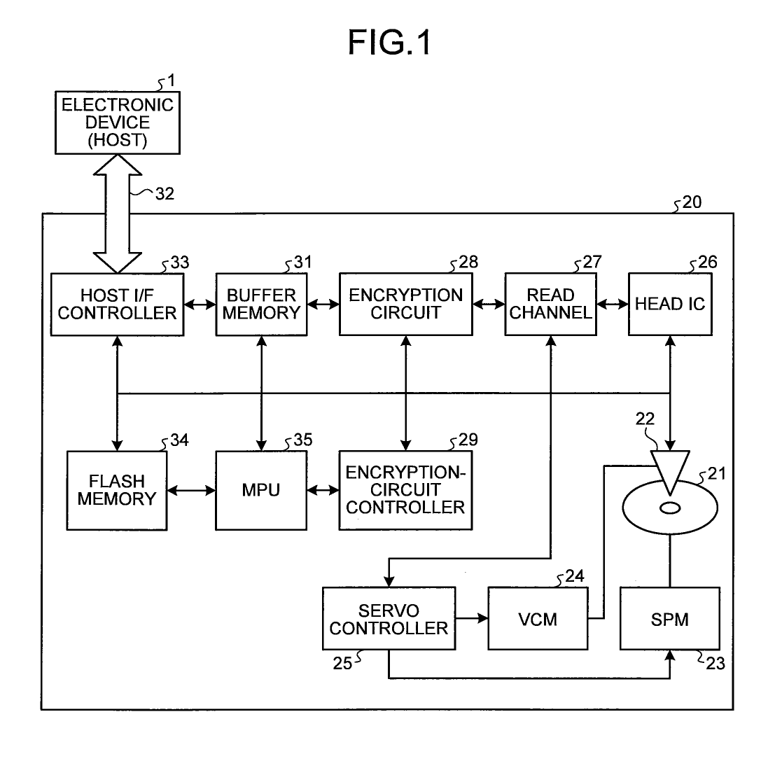

As illustrated in FIG. 1, a hard disk device 20 comprises a disk 21 as a storage module, a head 22, a spindle motor (SPM) 23, a voice-coil motor (VCM) 24, a servo controller 25, a head integrated circuit (IC) 26, a read channel 27, an encryption circuit 28, an encryption-circuit controller 29, a buffer memory 31, a host interface (I/F) controller 33, a flash memory 34, a micro processing unit (MPU) 35, and the like.

The disk 21 is a recording medium that magnetically records data thereon. The head 22 writes (records) data on the disk 21 and reads data written (recorded) on the disk 21. The SPM 23 drives the disk 21 to rotate. The VCM 24 has a magnet (not illustrated), a drive coil (not illustrated), and the like, and drives the head 22. The servo controller 25 controls the SPM 23 and the VCM 24. The head IC 26 amplifies a signal of data to be written to the disk 21 by the head 22 and a signal of data read from the disk 21 by the head 22. The read channel 27 is, for example, a circuit including a filter, an automatic gain controller (AGC), an analog-to-digital converter (ADC), a Viterbi decoder, and the like. The encryption circuit 28 encrypts data to be written to the disk 21 using a predetermined encryption key by a predetermined encryption scheme, such as advanced encryption standard (AES). The encryption circuit 28 decrypts data read from the disk 21 using a predetermined encryption key. The encryption-circuit controller 29 controls operation of the encryption circuit 28.

The buffer memory 31 temporarily stores data to be written to the disk 21, data read from the disk 21, and the like. The host I/F controller 33 controls transmission and reception of data and a command between an electronic device 1 and the hard disk device 20 via a host IF 32.

The flash memory 34 is a nonvolatile memory that stores a program to be executed by the MPU 35, various types of setting information relating to operation of the hard disk device 20, and the like.

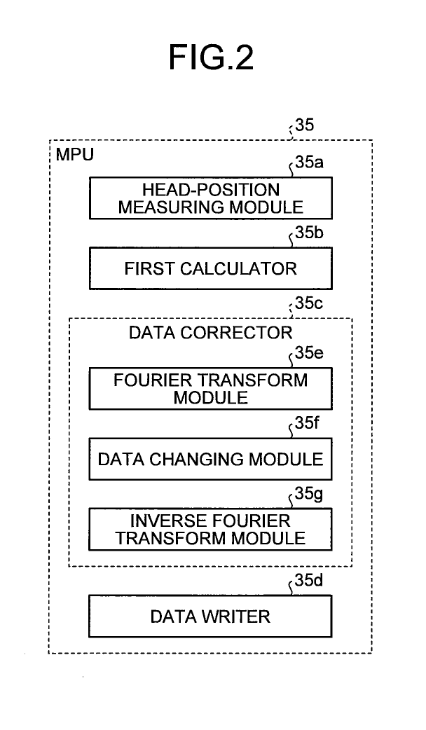

The MPU 35 loads a program stored in the flash memory 34 or the like and executes the program, thereby operating as functional modules, which will be described later (for example, a head-position measuring module 35a, a first calculator 35b, a data corrector 35c, a data writer 35d, a Fourier transform module 35e, a data changing module 35f, an inverse Fourier transform module 35g, and the like, see FIG. 2). Namely, the program includes modules operating as the head-position measuring module 35a, the first calculator 35b, the data corrector 35c, the data writer 35d, the Fourier transform module 35e, the data changing module 35f, the inverse Fourier transform module 35g, and the like. Operation of these functional modules will be described later.

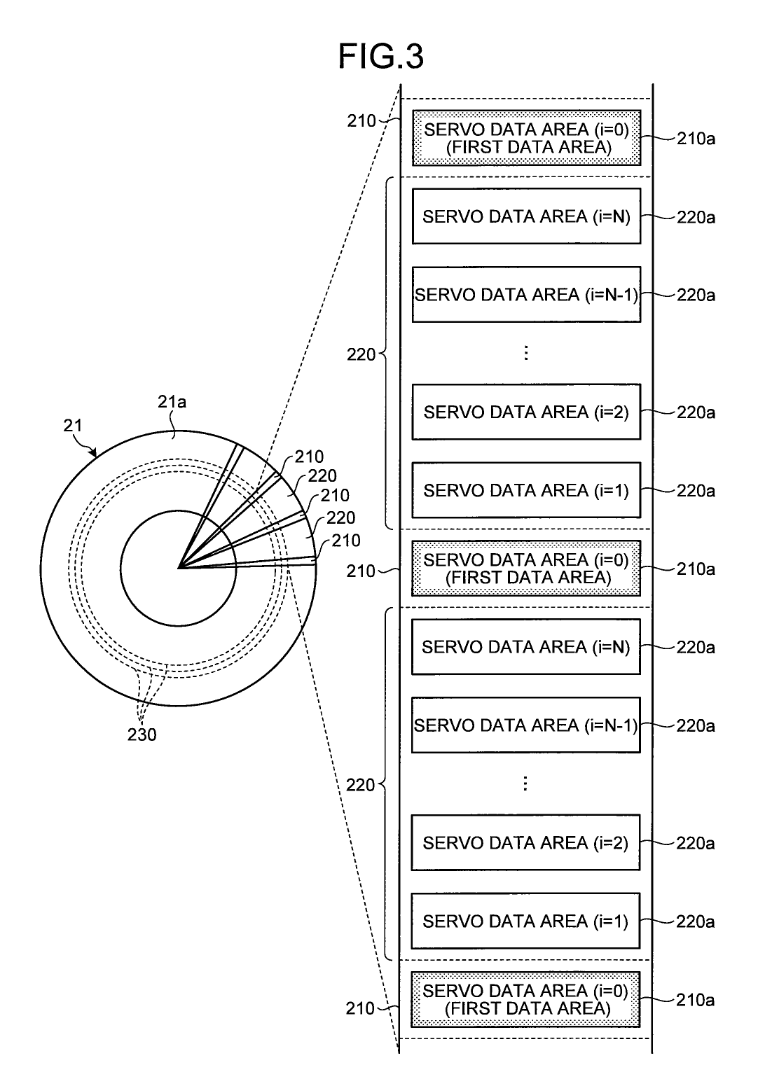

As illustrated in FIG. 3, on a surface 21a of the disk 21, a plurality of first data areas (first areas) 210 and a plurality of second data areas (second areas) 220 are provided. The first data areas 210 are arranged in a radial and belt-like manner at regular intervals in a circumferential direction. The second data areas 220 are located between an adjacent pair of the first data areas 210. The head 22 moves on the surface 21a of the disk 21 along a plurality of concentric tracks 230 relative to the disk 21. In the position of each first data area 210 corresponding to the tracks 230, servo data (first servo data, not illustrated in FIG. 3) is written. Namely, the first data area 210 corresponds to a servo frame. Each of the servo data includes a plurality of (for example, four) burst data. Besides, areas in each second data area 220 corresponding to the tracks 230 are storage areas for rewritable data (hereinafter, referred to as “user data”). By a commonly known technique, a displacement amount of the head or a correction amount for reducing (or eliminating) displacement of the head is calculated from a result of reading the servo data.

In the first embodiment, as illustrated in an enlarged portion on the right side of FIG. 3, also in the second data area 220 in which user data is rewritably recorded, a plurality of servo data (second servo data, not illustrated in FIG. 3) is written initially (i.e., at the manufacturing stage, at the stage before the hard disk device 20 is used). In the second data area 220, a plurality of servo data areas 220a in which servo data is written are arranged at equally-spaced intervals. Each of the first data areas 210 includes a plurality of servo data areas 210a in which is written servo data with respect to each track 230. The form of the servo data written in the second data area 220 (included data, a layout of the data, the number of data, etc.) is identical to that of the servo data written in the first data area 210. Namely, in the first embodiment, a plurality of servo data areas 210a and 220a each including the same form of servo data are arranged along the tracks 230 at a regular pitch (interval). Incidentally, in the example of FIG. 3, each of the second data areas 220 includes N servo data areas 220a, i.e., N pieces of servo data. The servo data is written on the surface 21a of the disk 21 by a commonly known technique (for example, by a servo track writer (not illustrated) or the like). After calculation of a displacement amount or a position correction amount, the second data areas 220 are used as user data areas. Accordingly, the servo data initially written in the second data areas 220 is rewritten to user data or deleted.

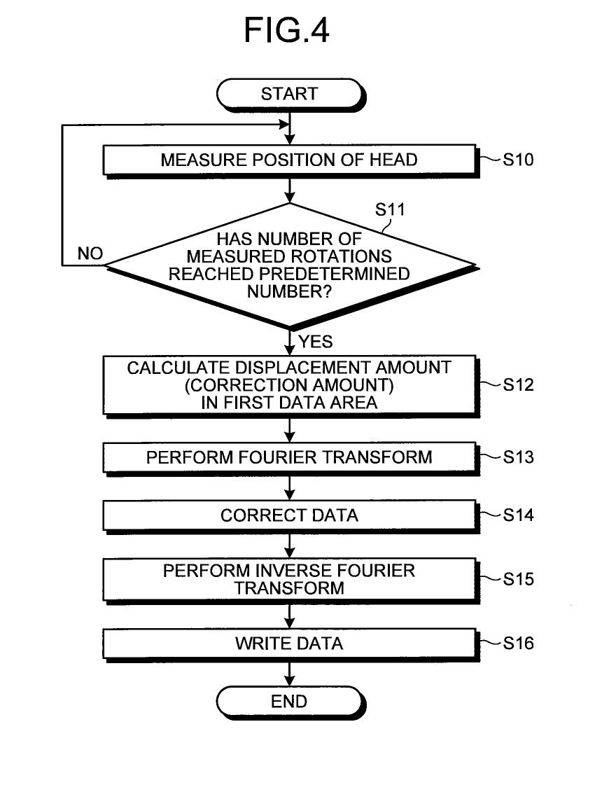

A description will be given of how to calculate a displacement amount or a correction amount in the hard disk device 20 of the first embodiment with reference to FIG. 4. Incidentally, a flow of FIG. 4 is performed after servo data is written in the first and second data areas 210 and 220 of the disk 21. Besides, in the flow of FIG. 4, both displacement amount and correction amount can be calculated; however, an example will be described below in which a displacement amount is calculated.

Upon receipt of a command from the electronic device 1 as a host or an inspection device (not illustrated), etc., the MPU 35 controls the servo controller 25 to drive the disk 21 to rotate. In this state, the MPU 35 operates as the head-position measuring module 35a and measures the position of the head 22 in each of the servo data areas 210a and 220a based on a result of reading servo data written in each of the servo data areas 210a and 220a (S10). At S10, by a commonly known technique, a displacement amount of the head 22 in each of the servo data areas 210a and 220a is calculated from a result of reading the servo data. The process at S10 is performed a predetermined number of times corresponding to the number of measurement revolutions (S11), and a displacement amount of the head 22 in each revolution is stored in a predetermined storage module (for example, the flash memory 34 or a register (not illustrated), etc.).

Next, the MPU 35 operates as the first calculator 35b and calculates displacement amounts respectively corresponding to the servo data areas 210a included in the first data area 210 (S12). In the first embodiment, at S12, the first calculator 35b calculates a displacement amount in each servo data area 210a based on the displacement amount of the head 22 in the servo data area 210a and the displacement amounts of the head 22 in servo data areas 220a stored in the predetermined storage module at S10. Namely, in the first embodiment, a displacement amount in the servo data area 210a is calculated based on a result of reading the servo data written in the servo data area 210a and results of reading the servo data written in servo data areas 220a adjacent to the servo data area 210a in the circumferential direction.

Specifically, at S12, based on a measurement result with respect to one revolution, the first calculator 35b first calculates a displacement amount δ(0) in the servo data area 210a, for example, as the average of a displacement amount δ(0) in the servo data area 210a and displacement amounts (δ(−n) to δ(−1), δ(1) to δ(n)) in the servo data areas 220a adjacent to the servo data area 210a on the same track 230 as the servo data area 210a. Namely, the first calculator 35b calculates a displacement amount δ(0) in the servo data area 210a as an average value (an arithmetic average value, an arithmetic mean value) of displacement amounts δ(i) (−n≦i≦n, 1≦n≦N: an integer) corresponding to a plurality of servo data. Here, i is a parameter indicating the position of each tier of the servo data areas 210a and 220a in the circumferential direction along the tracks 230. In the first embodiment, as an example, i is zero at the position of the servo data area 210a, and i increases in the clockwise direction and decreases in the counterclockwise direction. Therefore, if i is a positive number, it means that the servo data area 220a is located in the clockwise direction with respect to the servo data area 210a. On the other hand, if i is a negative number, it means that the servo data area 220a is located in the counterclockwise direction with respect to the servo data area 210a. Accordingly, a value of i of one servo data area 220a varies depending on a reference servo data area 210a. For example, i of one servo data area 220a is a negative number (a minus value) from the standpoint of the servo data area 210a located in the clockwise direction with respect to the servo data area 220a and is a positive number (a plus value) from the standpoint of the servo data area 210a located in the counterclockwise direction with respect to the servo data area 220a. Besides, N is the number of the servo data areas 220a provided in the second data area 220. Moreover, n can be represented as n=N/2 if N is an even number and n=(N+1)/2 or n=(N−1)/2 if N is an odd number.

Further, at S12, the first calculator 35b calculates a displacement amount δ(0) as an average value (an arithmetic average value, an arithmetic mean value) of the calculated displacement amounts δ(0) with respect to each revolution.

In this manner, in the first embodiment, a displacement amount δ(0) in the servo data area 210a (the first data area 210) is calculated based on a displacement amount δ(0) in the servo data area 210a and displacement amounts δ(i) in the servo data areas 220a (the second data areas 220) adjacent to the servo data area 210a in the circumferential direction. Therefore, compared to the case where the displacement amount δ(0) in the servo data area 210a is directly used, it is easier to increase the accuracy of the displacement amount δ(0) (or a correction amount) in the servo data area 210a and eventually the accuracy of positioning control. Furthermore, the displacement amount δ(0) or the correction amount is calculated using the servo data written in the servo data areas 220a (the second data areas 220). Therefore, compared to the case where the displacement amount δ(0) or correction amount is calculated using only the servo data written in the servo data area 210a (the first data area 210), a more highly accurate result can be obtained by increasing the number of samples even if the number of revolutions is small. Namely, according to the first embodiment, it is possible to reduce a time taken to calculate a displacement amount or a correction amount.

Moreover, in the first embodiment, a displacement amount δ(0) in the servo data area 210a is calculated using displacement amounts δ(i) in the adjacent servo data areas 220a on both sides of the servo data area 210a in the circumferential direction. Therefore, compared to the case where a displacement amount δ(0) in the servo data area 210a is calculated using only a displacement amount δ(i) in the adjacent servo data area 220a on one side of the servo data area 210a in the circumferential direction, it is easier to increase the accuracy of the displacement amount δ(0) (or a correction amount) in the servo data area 210a and eventually the accuracy of positioning control.

After the process at S12, the MPU 35 operates as the data corrector 35c and corrects the displacement amount δ(0) in the servo data area 210a. Namely, the MPU 35 first operates as the Fourier transform module 35e and performs Fourier transform (discrete Fourier transform) on a data string that the respective displacement amounts δ(0) in the servo data areas 210a (the first data areas 210) calculated at S12 are arranged in the circumferential direction with respect to each track 230 (S13). By the process at S13, a frequency component of the data string of the displacement amounts δ(0) in the servo data areas 210a on each track 230 is obtained.

Next, the MPU 35 operates as the data changing module 35f and adjusts the size of the frequency component of the data string of the displacement amounts δ(0) in the servo data areas 210a on each track 230 obtained at S13 (S14). This allows the data changing module 35f to reduce a value of a specific frequency component prone to be superimposed as an error caused by, for example, a natural frequency or vibration of the disk 21, the head, the arm, or other mechanisms and the like. At S14, for example, a specific frequency component and a reduction amount (a cut amount) with respect to the specific frequency component are arbitrarily set according to specifications of the hard disk device 20 or the disk 21 and are stored in a nonvolatile storage module such as the flash memory 34. Without specifying a frequency in advance, a value of a frequency component of which the frequency achieves a particularly-high peak as compared to other frequency components can be reduced.

Next, the MPU 35 operates as the inverse Fourier transform module 35g and performs inverse Fourier transform (inverse discrete Fourier transform) on the frequency component of the data string of the displacement amounts δ(0) in the servo data areas 210a on each track 230 corrected at S14 (S15). By the process at S15, the data string of the displacement amounts δ(0) in the servo data areas 210a on each track 230 with suppressed effect of the specific frequency component is obtained. By the processes at S13 to S15, the accuracy of a displacement amount δ(0) in each servo data area 210a (first data area 210) can be increased. p Next, the MPU 35 operates as the data writer 35d and writes the displacement amount δ(0) in each servo data area 210a in the corresponding servo data area 210a (first data area 210) using the head 22 (S16). Specifically, the displacement amount δ(0) is written, for example, after the burst data in the servo data area 210a as post data. After that, at the time of use of the hard disk device 20, positioning control is performed based on the displacement amount δ(0) (or correction amount) in the servo data area 210a which is determined by the flow of FIG. 4 and written to the disk 21.

At S12 described above, in the calculation of the displacement amount δ(0) (or correction amount) in the servo data area 210a, the displacement amount δ(0) calculated from a result of reading the servo data written in the servo data area 210a (the first data area 210) and the displacement amounts (δ(−n) to δ(−1), δ(1) to δ(n)) calculated from results of reading the servo data written in the servo data areas 220a (the second data areas 220) are the same in weighting coefficient (contributing rate) applied to the calculated displacement amount δ(0) or correction amount. The weighting coefficient may be changed depending on a distance from the servo data area 210a (the first data area 210) in the circumferential direction such that the weighting coefficient is reduced as the distance increases and is increased as the distance decreases. Specifically, the displacement amount δ(0) in the servo data area 210a can be calculated by the following Equation (1):

$$δ ( 0 ) = \frac{{\sum }_{i = - n}^{n} \{ {2}^{- \vert i \vert} \cdot δ ( i ) \}}{{\sum }_{i = - n}^{n} {2}^{- \vert i \vert}} \qquad ( 1 )$$

As an example, when the number N of the servo data in the second data area 220 on each track 230 is eight (i.e., N=8) and n=4, the above equation (1) is expressed as the following Equation (2):

$$δ ( 0 ) = \frac{\begin{matrix}\frac{1}{16} δ ( - 4 ) + \frac{1}{8} δ ( - 3 ) + \frac{1}{4} δ ( - 2 ) + \frac{1}{2} δ ( - 1 ) + δ ( 0 ) + \\ \frac{1}{2} δ ( 1 ) + \frac{1}{4} δ ( 2 ) + \frac{1}{8} δ ( 3 ) + \frac{1}{16} δ ( 4 )\end{matrix}}{\frac{1}{16} + \frac{1}{8} + \frac{1}{4} + \frac{1}{2} + 1 + \frac{1}{2} + \frac{1}{4} + \frac{1}{8} + \frac{1}{16}} \qquad ( 2 )$$

It is presumable that a position gap between the servo data in the servo data area 210a and the servo data in the servo data area 220a in a radial direction becomes larger as the servo data area 210a and the servo data area 220a separate from each other in the circumferential direction. Accordingly, using the above Equation (1) in which the weighting coefficient (contributing rate) is reduced as the servo data area 210a and the servo data area 220a separate from each other in the circumferential direction, a displacement amount δ(0) in the servo data area 210a is calculated as a weighted average of a plurality of displacement amounts δ(i) (i=−n to n). This makes it easier to increase the accuracy of the displacement amount δ(0) in the servo data area 210a compared to the case where a displacement amount δ(0) in the servo data area 210a is calculated simply as an arithmetic average (arithmetic mean) of a plurality of displacement amounts δ(i) without weighting the displacement amounts δ(i) (without taking the contributing rate into account). Incidentally, the weighting coefficient of the weighted average in the above Equations (1) and (2) is just an example, and the weighting coefficient can be set variously.

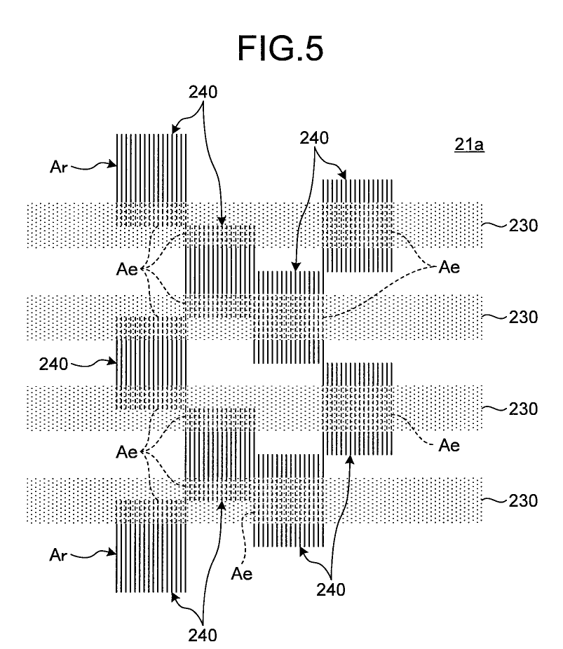

According to the first embodiment, the second data areas 220 are rewritable data recording areas, and the servo data initially written in the second data areas 220 is rewritten or deleted. Namely, as illustrated in FIG. 5, out of servo data 240 (burst data) initially written in the second data areas 220, areas Ae which overlap the tracks 230 may be deleted by use of the hard disk device 20. However, in the first embodiment, areas Ar of the servo data 240 which do not overlap the tracks 230 are likely to remain on the surface 21a of the disk 21 even after the start of use of the hard disk device 20, and the areas Ar persist as a vestige of the servo data 240 initially written in the second data area 220. Incidentally, an area on the surface 21a of the disk 21 on which the areas Ar of the servo data 240 are written corresponds to a third area in the first embodiment.

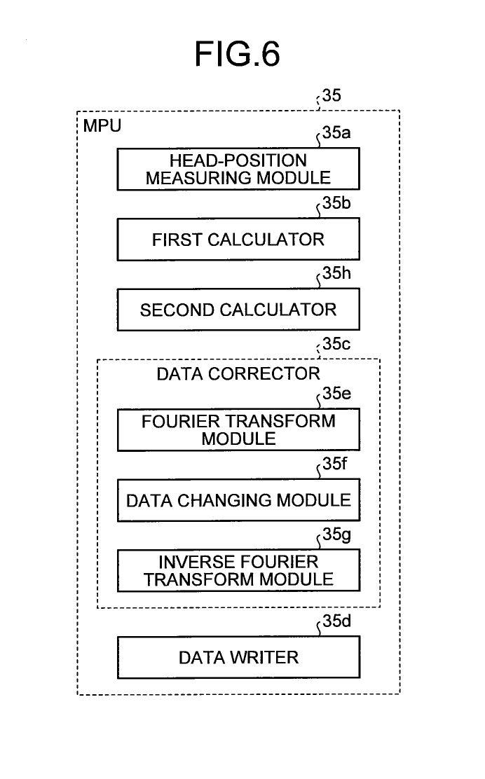

As is obvious from FIG. 6 in comparison to FIG. 2, in a second embodiment, the MPU 35 has a part functioning as a second calculator 35h. Operation of the functional modules including the second calculator 35h illustrated in FIG. 6 will be described later. Except for that the MPU 35 has the second calculator 35h and performs different calculation, the hard disk device 20 of the second embodiment has the same configuration as the hard disk device 20 of the first embodiment.

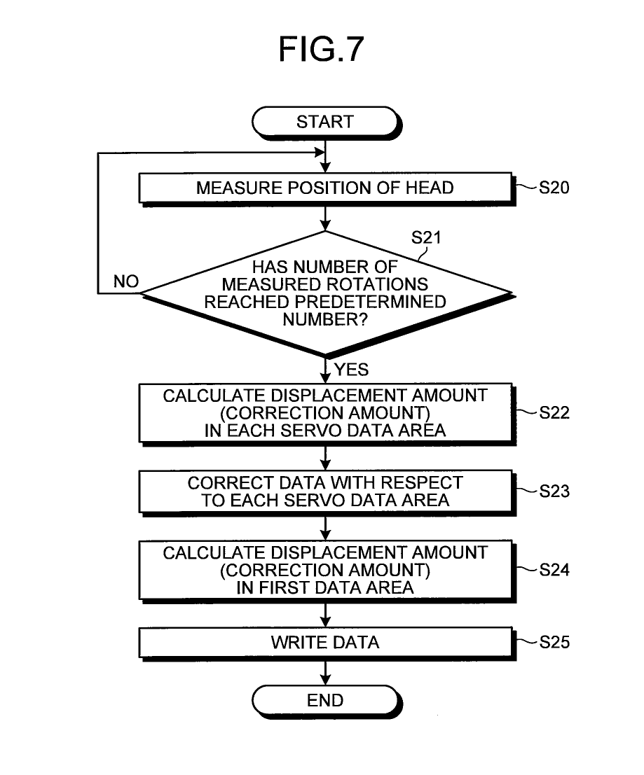

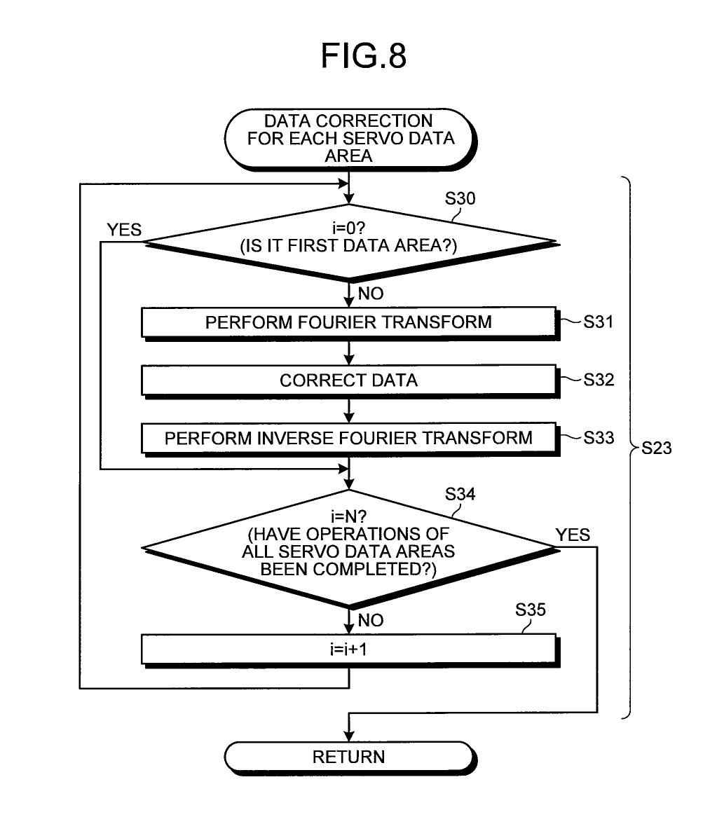

A description will be given of how to calculate a displacement amount or a correction amount in the hard disk device 20 of the second embodiment with reference to FIGS. 7 and 8. Incidentally, a flow of FIGS. 7 and 8 is performed after servo data is written in the first and second data areas 210 and 220 of the disk 21 in the same manner as in the above first embodiment. Besides, also in the flow of FIGS. 7 and 8, both displacement amount and correction amount can be calculated; however, an example will be described below in which a displacement amount is calculated.

The process at S20 is the same as described for S10 in the first embodiment, and the process at S21 is the same as described for S11 in the first embodiment.

After the process at S21, the MPU 35 operates as the second calculator 35h and calculates displacement amounts in the servo data areas 210a and 220a from results of reading the servo data written in the servo data areas 210a and 220a (S22). At S22, a displacement amount δ(i) in each of the servo data areas 210a and 220a is calculated as an average value (an arithmetic average value, an arithmetic mean value) of displacement amounts δ(i) with respect to a plurality of revolutions. Incidentally, at this stage, displacement amounts δ(i) in servo data areas 220a (second data areas 220) (for example, δ(−n) to δ(−1), δ(1) to δ(n)) are not reflected in a displacement amount δ(0) in the servo data area 210a (the first data area 210).

After the process at S22, the MPU 35 operates as the data corrector 35c and corrects data of the displacement amount δ(i) (i=1 to N) with respect to each of the servo data areas 210a and 220a (S23 (S30 to S35)).

At S23, the process at S31 to S33 in FIG. 8 is performed on each of N+1 data strings: a data string that displacement amounts δ(0) of a plurality of servo data areas 210a on each track 230 are arranged along the circumferential direction, a data string that displacement amounts δ(1) of servo data areas 220a located at positions displaced from the servo data areas 210a by one area in the clockwise direction are arranged along the circumferential direction, a data string that displacement amounts δ(2) of servo data areas 220a located at positions displaced from the servo data areas 210a by two areas in the clockwise direction are arranged along the circumferential direction, . . . , a data string that displacement amounts δ(i) of servo data areas 220a located at positions displaced from the servo data areas 210a by i areas in the clockwise direction are arranged along the circumferential direction, . . . , and a data string that displacement amounts δ(N) of servo data areas 220a located at positions displaced from the servo data areas 210a by N areas in the clockwise direction are arranged along the circumferential direction.

In the second embodiment, with respect to the data string of the displacement amounts δ(0) in the servo data areas 210a (the first data areas 210) (Yes at S30), the MPU 35 does not perform the processes at S31 to S33, i.e., does not correct the data. If the parameter i is zero (i=0), it means No at S34, and the flow goes to S35. At S35, the parameter i is incremented by one, and then the flow returns to S30.

With respect to the data string of the displacement amounts δ(i) (i=1 to N) in the servo data areas 220a (No at S30), the MPU 35 performs the processes at S31 to S33, i.e., corrects the data. At S31 to S33, the MPU 35 operates as the data corrector 35c in the same manner as in the above first embodiment. However, in the second embodiment, the MPU 35 operating as the Fourier transform module 35e performs Fourier transform (discrete Fourier transform) on the above-mentioned data string of the displacement amounts δ(i) (S31). By the process at S31, a frequency component of the data string of the displacement amounts δ(i) in the servo data areas 220a on each track 230 is obtained.

Next, the MPU 35 operates as the data changing module 35f and adjusts the size of the frequency component of the data string of the displacement amounts δ(i) in the servo data areas 220a on each track 230 calculated at S31 (S32). At S32, as an example, a frequency component of a frequency equal to or higher than a predetermined value (i.e., a high-order component) is eliminated, i.e., is set to zero. Incidentally, at S32, the data may be changed in the same manner as at S14 as described in the first embodiment such as to reduce a value of a specific frequency component.

Next, the MPU 35 operates as the inverse Fourier transform module 35g and performs inverse Fourier transform (inverse discrete Fourier transform) on the frequency component of the data string of the displacement amounts δ(i) in the servo data areas 220a on each track 230 corrected at S32 (S33). By the process at S33, the data string of the displacement amounts δ(i) in the servo data areas 220a on each track 230 with suppressed effect of the high-order component is obtained.

At S35, the parameter i is sequentially incremented by one, and if the process on all the data strings in the servo data areas 220a is completed (i.e., i=N, Yes at S34), the flow goes to S24 in FIG. 7. At S24, the MPU 35 operates as the first calculator 35b and calculates a displacement amount δ(0) in the servo data area 210a, for example, as the average of a displacement amount δ(0) in the servo data area 210a and displacement amounts (δ(−n) to δ(−1), δ(1) to δ(n)) in a plurality of servo data areas 220a. Namely, the first calculator 35b calculates a displacement amount δ(0) in the servo data area 210a as an average value (an arithmetic average value, an arithmetic mean value) of displacement amounts δ(i) n; N: an integer) with respect to a plurality of servo data. Next, the MPU 35 operates as the data writer 35d in the same manner as at S16 (S25).

As described above, according to the second embodiment, a result of reading servo data in the servo data area 210a (the first data area 210) is directly used. Meanwhile, from a result of reading servo data in a servo data area 220a (the second data area 220), the adverse effect of a high-order component is suppressed. Thus, it is easier to further increase the positioning accuracy.

The above embodiments are susceptible to susceptible to modifications and alternative forms. For example, the weighting coefficient used in weighted average of a plurality of displacement amounts can be changed variously. The number of servo data in a second data area used in calculation of a displacement amount or a correction amount in a first data area is not limited to that is described in the above embodiments and can be changed variously. Moreover, it can be configured to use servo data in a second data area adjacent to a first data area without using servo data in a second data area away from the first data area. Furthermore, an operation relating to the calculation of a displacement amount or a correction amount can be performed by a controller other than the MPU of the hard disk device or an electronic device other than the hard disk device. Regarding the hard disk device, the disk, the head, the first data areas, the second data areas, the servo data areas, the servo data, and the like, the specifications (structure, shape, size, length, width, thickness, height, number, arrangement, location, color, design, pattern, form, and the like) can be suitably modified.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A hard disk device comprising:
a disk comprising a plurality of first areas arranged spaced apart in a circumferential direction on a surface of the disk and data-rewritable second areas each located between an adjacent pair of the first areas in the circumferential direction, first servo data being written in the first areas, second servo data being written in the second areas;
a head configured to read the first servo data and the second servo data written to the surface of the disk; and
a calculator configured to calculate a displacement amount or a position correction amount of the head based on a result of reading the first servo data and the second servo data by the head.

2. The hard disk device of claim 1, wherein the calculator is configured to calculate a displacement amount or a position correction amount of the head in each of the first areas based on a result of reading second servo data written in second areas on both sides of the first area in the circumferential direction.

3. The hard disk device of claim 2, wherein
in calculation of the displacement amount or the position correction amount of the head by the calculator, a weighting coefficient to be applied to the displacement amount or the position correction amount is set with respect to each of a result of reading the first servo data and a result of reading the second servo data, and
the weighting coefficient with respect to the result of reading the second servo data is smaller than the weighting coefficient with respect to the result of reading the first servo data.

4. The hard disk device of claim 3, wherein
a plurality of pieces of second servo data are circumferentially arranged and written in each of the second areas, and
as the second area is separate from a first area in the circumferential direction, the weighting coefficient is smaller with respect to a result of reading second servo data written in the second area.

5. The hard disk device of claim 1, further comprising:
a Fourier transform module configured to perform Fourier transform on data strings of displacement amounts or correction amounts calculated by the calculator which are aligned in order along the circumferential direction;
a data changing module configured to change data obtained as a result of the Fourier transform; and
an inverse Fourier transform module configured to perform inverse Fourier transform on the data changed by the data changing module.

6. The hard disk device of claim 5, wherein, with respect to the data obtained through the Fourier transform of the data strings of the displacement amounts or the correction amounts calculated from the result of reading the second servo data by the Fourier transform module, the data changing module is configured to reduce a value of a frequency component equal to or higher than a predetermined frequency.

7. A disk for a hard disk device, comprising:
a plurality of first areas arranged spaced apart in a circumferential direction on a surface of the disk, first servo data being written in each of the first areas; and
a data-rewritable second area located between an adjacent pair of the first areas in the circumferential direction, wherein
second servo data is written in a third area adjacent to the second area in a radial direction.

8. A method for calculating a displacement amount or a position correction amount of a head applied to a hard disk device comprising the head configured to read data written on a surface of a disk, the method comprising:
writing first servo data in a plurality of first areas arranged spaced apart in a circumferential direction on the surface of the disk;
writing second servo data in a data-rewritable second area located between an adjacent pair of the first areas in the circumferential direction on the surface of the disk; and
calculating a displacement amount or a position correction amount of the head based on a result of reading the first servo data and the second servo data by the head.

9. The method of claim 8, wherein the calculating includes calculating a displacement amount or a position correction amount of the head in each of the first areas based on a result of reading second servo data written in second areas on both sides of the first area in the circumferential direction.

10. The method of claim 9, wherein
the calculating includes setting a weighting coefficient to be applied to the displacement amount or the position correction amount with respect to each of a result of reading the first servo data and a result of reading the second servo data, and
the weighting coefficient with respect to the result of reading the second servo data is smaller than the weighting coefficient with respect to the result of reading the first servo data.

11. The method of claim 10, further comprising writing a plurality of pieces of second servo data circumferentially arranged in each of the second areas, wherein
as the second area is separate from a first area in the circumferential direction, the weighting coefficient is smaller with respect to a result of reading second servo data written in the second area.
